(19) United States
(12) Patent Application Publication
(10) Pub. No.: US 2003/0152387 A1
(43) Pub. Date: Aug. 14, 2003

(54) Method for transmitting multi-level signals through dispersive media

(76) Inventors: Irl N. Duling, Lancaster, PA (US); Sandeep T. Vohra, Ellicott City, MD (US); Paul J. Matthews, Ellicott City, MD (US)

Correspondence Address: PILLSBURY WINTHROP, LLP, P.O. BOX 10500, MCLEAN, VA, 22102, US

(21) Appl. No.: 10/308,197

(22) Filed: Dec. 3, 2002

Related U.S. Application Data
(60) Provisional application No. 60/334,922, filed on Dec. 4, 2001.

(51) Int. Cl. H04J 14/02; H04B 10/00

(52) U.S. Cl. 398/81; 398/147; 398/141

(57) ABSTRACT

An optical communication system has an optical transmitter, an optical transmission line in optical communication with the optical transmitter, an optical receiver in optical communication with the optical transmission line, and a dispersion compensator disposed between the optical transmitter and the optical receiver along the optical transmission line. The optical transmitter is adapted to transmit an optical signal that includes multilevel encoding. The optical transmission line causes a first dispersion of the optical signal and the dispersion compensator causes a second dispersion of the optical signal. The second dispersion at least partially cancels the first dispersion.

This Application is based on Provisional Application No. 60/334,922 filed Dec. 4, 2001, the entire contents of which is hereby incorporated by reference.

### BACKGROUND

1. Field of Invention

This invention relates to optical transmission systems and more particularly to methods and devices for transmitting multi-level coded signals through dispersive media.

2. Discussion of Related Art

Demand for optical communication systems is growing with the growing demand for faster broadband and more reliable networks. Wavelength division multiplexing (WDM) is one technique used to increase the capacity of optical communication systems. Such optical communication systems include, but are not limited to, telecommunication systems, cable television systems (CATV), and local area networks (LANs). An introduction to the field of Optical Communications can be found in “Optical Communication Systems” by Gowar, ed. Prentice Hall, NY, 1993.

WDM optical communication systems carry multiple optical signal channels, each channel being assigned a different wavelength. Optical signal channels are generated, multiplexed to form an optical signal comprised of the individual optical signal channels, and transmitted over a single waveguide such as an optical fiber. The optical signal is subsequently demultiplexed such that each channel corresponding to a wavelength is individually routed to a designated receiver.

In wavelength division multiplexing, the transmitted wavelengths are locked to one of the International Telephone Union (ITU) standard wavelengths, called the ITU grid, to meet cross-talk specification and reliability in operation over time. Technologies such as Distributed Feedback Lasers (DFB) are used to provide a source at a desired wavelength for the ITU grid.

In optical communication systems which utilize an optical fiber as a transmitting medium, dispersion and fiber non-linearities present obstacles to achieving higher system data rates and longer repeater-less transmission distances. Dispersion is the phenomenon wherein different wavelength components of a transmitted signal travel at different velocities in the optical fiber and thus the optical components arrive at the receiver at different times. Consequently, an optical signal pulse launched into an optical fiber tends to broaden or smear as it propagates in the optical fiber. Therefore, the optical signal pulse arrives at the receiver smeared. More importantly, when a series of optical pulses are launched into the optical fiber at specific time intervals, the optical pulses having the tendency to broaden as they are propagating in the optical fiber, causes closely spaced light pulses to overlap in time. The overlap can have an undesirable effect since this will lead to optical signal interference which in turn limits the data bandwidth of the optical fiber.

Several forms of dispersion arise in optical communication systems. One of the dispersion forms that occurs in optical fibers is the chromatic dispersion. Chromatic dispersion plays an important role in the design of single-mode transmission systems. For this reasons, it is often referred to by the use of the term “dispersion.”

There are many characteristics of dispersion and these include first, second and third order dispersion. First order dispersion, often referred to as group velocity, is the rate of change of the index of refraction with respect to wavelength in the optical fiber. Second order dispersion, which is responsible for broadening, i.e. smearing, of an optical pulse, is the rate of change of the first order dispersion, i.e., group velocity, with respect to wavelength. Second order dispersion is often called group velocity dispersion (GVD). Third order dispersion, often referred to as the dispersion slope, is the rate of change of broadening with respect to a change in wavelength.

In mathematical terms, the chromatic dispersion arises because the propagation constant β is not proportional to the angular frequency ω, i.e. dβ/dω is not a constant (independent of ω). dβ/dω is denoted by β1 and β1⁻¹ is called the group velocity. The group velocity is the velocity with which a pulse propagates through the optical fiber in the absence of dispersion. The first and second order group velocity dispersion, respectively denoted as β2 and β3, correspond to the second and third derivatives of the propagation constant β with respect to the angular frequency ω. Higher order dispersion terms are present but can be approximated to zero in most applications.

In a digital transmission system, signals which are constituted of a series of ones and zeros are sent from a transmitter to a receiver. The receiver must be able to distinguish ones from zeros. This requirement puts certain limitations on the signal to noise ratio of the signal at the receiver. Moreover, higher bit rate signals are more susceptible to the effects of dispersion. If the transmitted signal consists of multi-level coded data such as duo-binary, quadrature modulated (QAM), or analog, then the requirement on the signal to noise ratio as well as the requirement on the dispersion are increased. A pure binary signal can be represented by on-off keyed encoding in which the on-off states represent the two values (0, 1). A multilevel coded signal has states that represent more than simply an on or off value. In the limit of infinite values, the multilevel signal corresponds to an analog signal.

When a signal is encoded onto an optical carrier using multiple levels of amplitude and phase, the signal is very sensitive to the phase relationship between various frequency components of the optical signal. The frequency components are carried by a spread of wavelengths. The distance at which an optical signal can propagate is reduced due to the dispersive effects that are induced upon the frequency components of the optical signal. Indeed, as discussed previously, due to the dependence of the propagation constant on the frequency, the frequency components in the optical signal are subject to different propagation velocities which can lead to interference between the components frequencies of the signal and thus ultimately leading to deterioration of the signal-to-noise ratio.

Although chromatic dispersion compensation has been used to mitigate the problem of dispersion in the propagation of on-off-keyed (OOK) signals in communications for a number of years, the problem of chromatic dispersion in multi-levels coded signals remained a problem. The problem of dispersion is more acute in the transmission of multi-level coded signals than on-off-keyed signals.

### SUMMARY

An aspect of the invention is to provide an optical communication system including an optical transmitter, an optical transmission line in optical communication with the optical transmitter, an optical receiver in optical communication with the optical transmission line, and a dispersion compensator disposed between the optical transmitter and the optical receiver along the optical transmission line. The optical transmitter is adapted to transmit an optical signal that includes multilevel encoding, and the optical transmission line causes a first dispersion of the optical signal and the dispersion compensator causes a second dispersion of the optical signal. The second dispersion at least partially cancels the first dispersion.

In one embodiment of the invention, the dispersion compensator includes a chirped fiber Bragg grating. In another embodiment of the invention the dispersion compensator includes a length of optical fiber having different dispersion characteristics than the optical transmission line. In yet another embodiment, the dispersion compensator includes an optically resonant component.

In an embodiment of the invention, the optical communication system, further includes a second optical transmitter in communication with the optical transmission line, and an optical multiplexer arranged between the optical transmission line and the first mentioned and the second optical transmitters. The optical multiplexer is structured to form a wavelength division multiplexed optical signal from optical signals from the first mentioned and the second optical transmitters.

The term “multilevel coded signal” is intended to broadly cover any non-purely on-off encoding scheme. For example, multilevel coded signals include quadrature amplitude modulated signal, quadrature phase shift keyed modulated signal, analog modulated signal, phase-shift keyed (PSK) and/or duobinary encoding. In addition, various transmission formats such as single sideband modulation, subcarrier multiplexing and/or a combination thereof may be used.

A further aspect of the invention is to provide a method of transmitting information in optical form. The method includes forming an optical signal comprising at least some multilevel encoding, transmitting the optical signal between a first location and a second location in a dispersive medium where the optical signal undergoes a first dispersion. The method further includes transmitting the optical signal through a dispersion compensator where the optical signal undergoes a second dispersion. The second dispersion at least partially cancels the first dispersion.

### BRIEF DESCRIPTION OF THE DRAWINGS

These and other objects and advantages of the invention will become more apparent and more readily appreciated from the following detailed description of the presently preferred exemplary embodiments of the invention taken in conjunction with the accompanying drawings, of which:

FIG. 1 is a schematic representation of an optical transmission system carrying a dispersion compensator according to one embodiment of the present invention;

FIG. 2 is a schematic representation of an optical transmission system carrying a dispersion compensator according to another embodiment of the present invention;

FIG. 3 is a schematic representation of a wavelength division multiplexing transmission system incorporating a dispersion compensator according to the invention; and

FIG. 4 is a schematic representation of a wavelength division multiplexing transmission system incorporating a plurality of dispersion compensators according to the invention.

### DETAILED DESCRIPTION

In the following description, in order to facilitate a through understanding of the invention and for purposes of explanation and not limitation, specific details are set forth such as particular optical and electrical circuits, circuit components, techniques, etc. However, the invention may be practiced in other embodiments that depart from these specific details. The terms optical and light are used in a broad sense in this description to include both visible and non-visible and non-visible regions of the electromagnetic spectrum. Currently, infrared light is used extensively in transmitting signals in optical communication systems. Infrared light is included within the broad meaning of the term light as used herein.

In optical transmission of multi-level coded signals, there are at least two sources of signal degradation due to dispersion. The first source of signal degradation is the distortion of the signal due to the dephasing of spectral components of the signal. The second source of signal degradation is the increased noise floor due to the conversion of phase noise of the optical laser source into amplitude noise. The conversion of phase noise into amplitude noise occurs in the optical signal because of the dispersion effects in the optical transmission medium, such as the optical fiber. The conversion of phase noise into amplitude noise is increased by the non-linearity of the optical transmission medium (optical fiber).

Since the signal-to-noise ratio is seen as critical in multi-level coded signals, it is judicious to not only have a low noise contribution from the laser transmitter and the transmission medium, but also to have a high optical power in order to maximize the power at the receiver end, and thus maximize the signal-to-noise ratio.

Both of the two sources of signal degradation are substantially reduced, if not eliminated, by reducing the dispersion in the communication channel. This is accomplished by incorporating a dispersion compensator into the transmission line between the transmitter and the receiver.

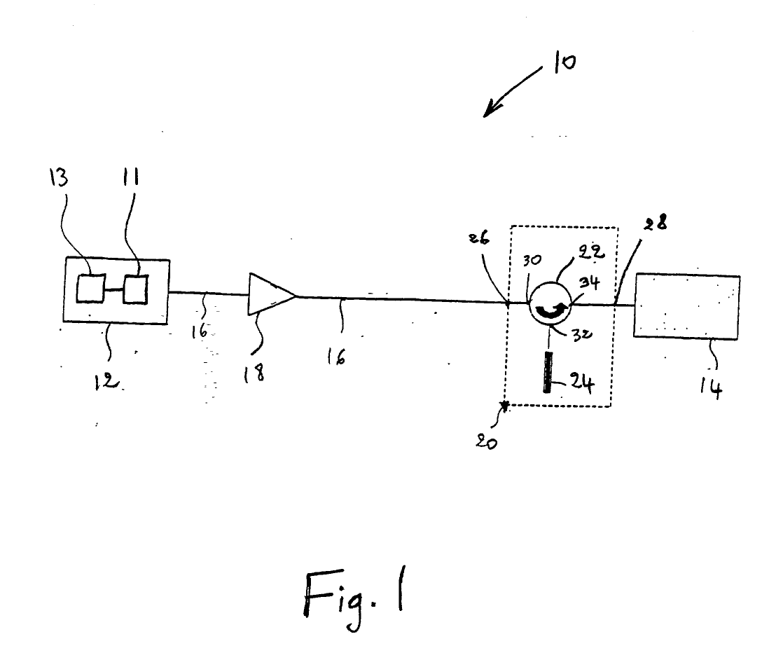

FIG. 1 shows a schematic representation of an optical transmission system having a dispersion compensator according to one embodiment of the present invention. In this embodiment, the transmission system 10 includes transmitter 12, receiver 14, transmission line 16, optical amplifier 18, and dispersion compensator 20. Optical amplifier 18 is a schematic representation that is intended to include either a single optical amplifier, or a plurality of optical amplifiers. In addition, the optical amplifier(s) may be localized, lumped amplifier(s) such as EDFAs or may be distributed amplifiers such as Raman amplifiers.

The transmitter 12 includes a source of optical radiation such as a laser 11, and a modulator unit 13. The modulator unit 13 is in communication with the optical radiation source 11 such that the light emitted by the optical radiation source is modulated with signal information communicated to the modulator to form the optical signal. The signal information may be electrical signals in various forms.

In one embodiment of the invention, modulated electrical signals are first produced by modulating electrical subcarriers. The signal may be modulated using various modulation schemes such as quadrature amplitude modulation (QAM), quadrature phase shift keyed (QPSK), duo-binary, or analog modulation. The electrical signals are then used to modulate optical signals. The signals may be multiplexed with one or more signals in the electrical domain prior to modulating it onto an optical signal. For example, one may subcarrier modulate the signals onto a radio-frequency (RF) carrier.

Direct modulation of the laser may be used to modulate the signals onto an optical carrier. Direct modulation of the laser may be achieved by varying the drive voltage to the laser which causes the output power to vary. In another embodiment, external modulation may be used to modulate the light beam emitted by the laser and in this instance a Mach-Zehnder modulator may be used. A Mach-Zehnder modulator is, for example, well suited for phase or frequency modulation of the light beam. These are examples of optical modulation techniques and devices. The invention is not limited to only these specific examples of modulation techniques, which are provided here to help emphasize that the term “optical modulation” is intended in its broadest sense.

Other embodiments of transmitter 12 are described in detail in a co-pending, commonly assigned application entitled “Efficient Optical Transmission System,” Attorney Docket Number 082134-0291417, which is incorporated, in its entirety, herein by reference.

The transmitter 12 converts an electrical signal into an optical signal and the optical signal is launched into optical transmission line 16. The optical signal can be a multi-level coded signal, for example a quadrature amplitude modulated signal, quadrature phase shift keyed (QPSK) signal, duobinary modulated signal, or analog modulated signal. In addition, various transmission formats such as single sideband modulation, subcarrier multiplexing and/or a combination thereof may be used. The signal may also be hybrid multilevel and binary signal. The optical signal is then amplified by optical amplifier 18. The optical signal may carry a variety of signals such as video signals, audio signals, data signals or a combination thereof.

Optical amplifier 18 can be a lumped optical amplifier or a distributed amplifier. A lumped optical amplifier may be selected from, for example, conventional erbium-doped fiber amplifiers (EDFA). Suitable distributed amplifiers include Raman amplifiers or erbium doped along a portion of transmission line itself 16 (e.g., optical fiber).

Erbium doped fiber amplifiers can provide gain over a linewidth of about 40 nm centered on 1530 nm. The gain is a function of doping concentration and the length of the fiber used and it depends also on the power and the spectral distribution of the pump radiation. It has been found that a gain of up to 20 dB can be obtained in 10-20 m of fiber doped with up to 100 ppm of erbium, using about 100 mW of pump power.

The transmission line 16 can be for example an optical fiber having a linear loss and a nonlinear refractive index. In most situations, transmission line 16 is constituted of a material having certain dispersive characteristics at the transmission frequencies. Therefore, the transmission line 16 has a propagation constant that depends on the frequency of the optical signal, or components thereof, propagating in the transmission line 16.

In order to substantially reduce, or even eliminate, the effect of the dependence of the propagation constant on frequency, the dispersion compensator 20 is integrated into the transmission system 10. Dispersion compensator 20 comprises components 22 and 24. Component 22 can be, for example, an optical circulator and component 24 can be, for example, a chirped in-fiber Bragg grating. Dispersion compensator 20 has a propagation constant that is opposite in sign to the propagation constant of transmission line 16 for at least one of the transmission wavelengths. Dispersion compensator 20 has input port 26 and output port 28. The dispersion compensator is connected to transmission line 16 through ports 26 and 28.

The optical circulator 22 has three optical ports 30, 32 and 34. The optical port 30 of optical circulator 20 is optically coupled to input port 26. The optical port 32 is optically coupled to chirped in-fiber Bragg grating 24. The optical port 34 is optically coupled to output port 28.

When a multi-level coded optical signal is launched into transmission line 16, the optical signal having components of various frequencies tends to be dispersed due to the dependence of the index of refraction on the frequency. The optical signal, comprised of various frequency (wavelength) components, enters the dispersion compensator 20 at input port 26 and exits the dispersion compensator at output port 28.

The optical signal, i.e. light, entering by input port 26 further enters the optical circulator 22 via its port 30 and emerges at its port 32 to which chirped in-fiber Bragg grating 24 is optically coupled. The light that is reflected by the Bragg grating 24 re-enters the circulator via its port 32 and re-emerges at its port 34. The light is then transmitted to output port 28 and injected back into transmission line 16.

For example, if the optical signal containing λ1, λ2, λ3, . . . , λi (with λ1<λ2<λ3< . . . <λi) wavelength components, is transmitted through the transmission line 16, the wavelength components will suffer from dispersion due to the dependence of the index of refraction on the frequency (wavelength). As stated previously, the group velocity is the rate of change of the index of refraction with respect to wavelength.

The group velocity Vg in a bulk medium is given by (dβ/dω)⁻¹ where ω is the angular frequency and β is the propagation constant. The group velocity can be derived by knowing β=ωn/c (n being the complex index of the material) to obtain

Vg=(1/c)[n+ω(dn/dω)]⁻¹. (I)

With the transformation

dn/dω=(dn/dλ)(dλ/dω), (II)

the relationship of Vg to the wavelength λ and the index n is

Vg=c[n−λ(dn/dλ)]⁻¹. (III)

Thus the group time delay Tg is

Tg=L/Vg=(L/c)[n−λ(dn/dλ)], (IV)

where L is the distance of travel through the medium.

If the variation of the refractive index is such that n(λ1)>n(λ2)>n(λ3) . . . >n(λi) as in glass, the derivative dn/dλ is negative, meaning that the group velocity decreases with increasing wavelength (see, formula III). This in turn implies that the group time delay increases with increasing wavelength (see, formula IV) in this example. In other words, the longer wavelength components will take more time to travel than the shorter wavelength components and thus dispersion occurs in the propagation medium, i.e., transmission line. In order to correct for the dispersion, a dispersion compensator including a chirped fiber Bragg grating is added into the transmission line.

A chirped fiber Bragg grating is an optical fiber with spatially modulated refractive index that is designed so that, for example, shorter wavelength components are reflected at a farther distance along the chirped fiber Bragg grating than are the longer wavelength components. In this way, the shorter wavelengths will travel a longer distance than the longer wavelengths and thus a time delay is added to the shorter wavelengths.

By causing certain wavelength components to travel longer distances than other wavelength components, a controlled delay is added to those components and opposite dispersion can be added to a pulse. A chirped fiber Bragg grating has a very narrow bandwidth for reflecting pulses. Therefore, in some instances where wavelength bandwidth of the signal is broader than the bandwidth of the chirped fiber Bragg grating, a number of chirped fiber Bragg gratings may be added in series or distributed along a transmission line. In this case, increased wavelength bandwidth coverage is provided to sufficiently compensate for light comprising many wavelengths, such as in a wavelength division multiplexed optical signal.

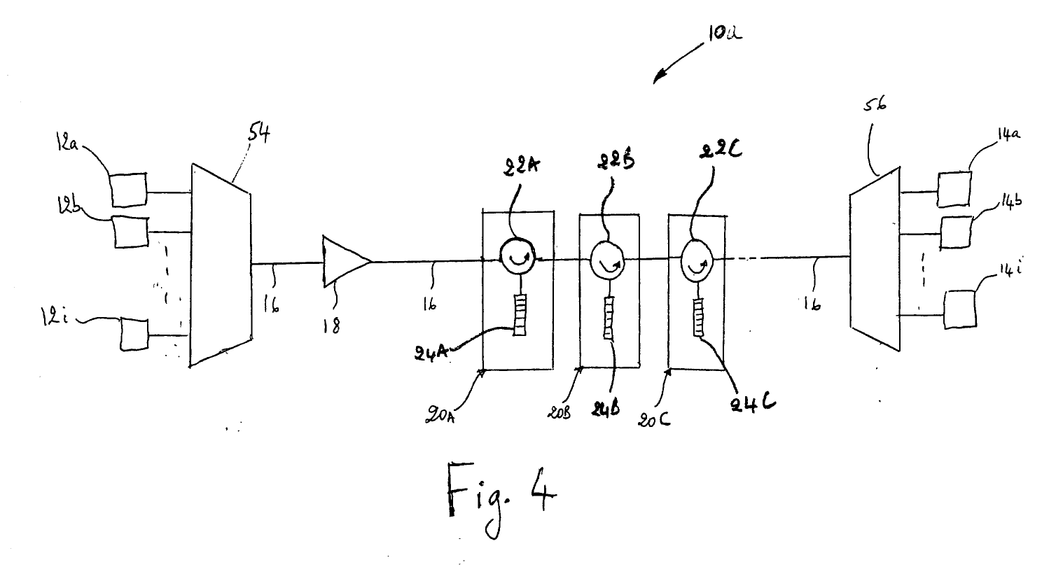

FIG. 4 shows a wavelength division multiplexing transmission system 10aincorporating a plurality of dispersion compensators arranged along the transmission line 16. Dispersion compensators 20A, 20B and 20C comprise chirped fiber Bragg gratings 24A, 24B and 24C respectively. Chirped fiber Bragg gratings 24A, 24B and 24C are provided with different chirped Bragg gratings to allow broader coverage of wavelength bandwidth in order to compensate for dispersion of light in a wavelength division multiplexed signal exiting wavelength division multiplexer 54. Dispersion compensators 20A, 20B and 20C further comprise optical circulators 22A, 22B and 22C, respectively. Optical circulators 22A, 22B and 22C are provided to optically couple the fiber Bragg gratings 24A, 24B and 24C to the optical transmission line 16. Although only three dispersion compensators 20A, 20B and 20C are shown in FIG. 4, one would appreciate that more than 3 dispersion compensators may be added into transmission line 16. One may also use a plurality of chirped fiber Bragg gratings arranged in series in place of any of chirped gratings 24, 24A, 24B, 24C without departing from the scope of this invention.

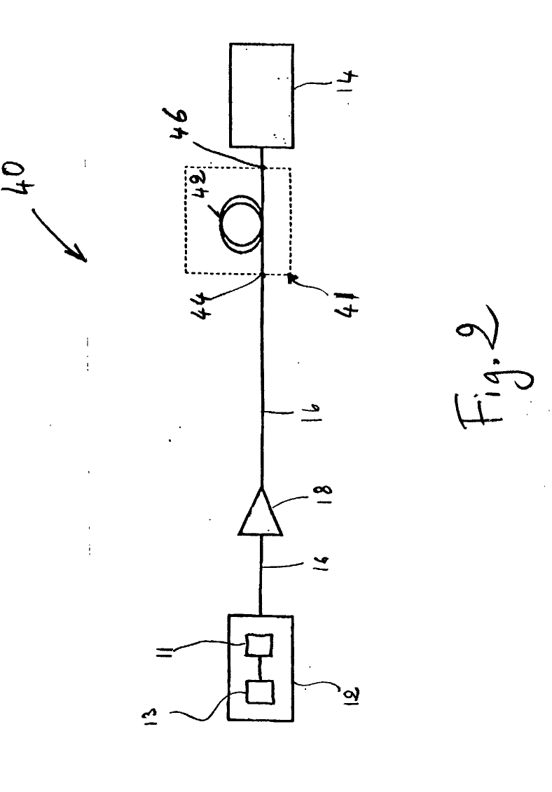

FIG. 2 shows a schematic representation of an optical transmission system having a dispersion compensator according to another embodiment of the present invention. In this embodiment, the transmission system 10 includes transmitter 12, receiver 14, transmission line 16, optical amplification 18, and dispersion compensator 41.

Similarly to the embodiment illustrated in FIG. 1, the transmitter 12 includes a source of optical radiation such as a laser 11, and a modulator unit 13. The modulator unit 13 is in communication with the source of optical radiation 11 such that the light emitted by the optical radiation source is modulated with baseband complex signals and waveforms to form the optical signal.

The transmitter 12 converts an electrical signal into an optical signal and the optical signal is launched into optical transmission line 16. The optical signal can be a multi-level coded or hybrid signal, for example including a quadrature amplitude modulated signal, quadrature phase shift keyed (QPSK) signal, duobinary modulated signal, sideband modulated signal, or analog modulated signal. The optical signal may then be amplified by optical amplifier 18.

The transmission line 16 can be, for example, an optical fiber having a linear loss and a nonlinear refractive index. In most situations, transmission line 16 is constituted of a material having certain dispersive characteristics at the transmission frequencies. Therefore, the transmission line 16 has a propagation constant that depends on the frequency of the optical signal, or components thereof, propagating in the transmission line 16.

In order to substantially reduce, or even eliminate, the effect of the dependence of the propagation constant, a dispersion compensator 41 is integrated into the transmission system 40. Dispersion compensator 41 comprises a section of optical fiber 42 that has a propagation constant opposite in sign to that of the transmission line 16. Dispersion compensator 41 has input port 44 and output port 46. The dispersion compensator is connected to transmission line 16 through ports 44 and 46.

The optical fiber section 42 is incorporated in-line within the transmission line 16. The optical fiber section 42 has a refractive index profile along its cross-section designed to provide chromatic dispersion that is opposite to that of the optical fiber of transmission line 16. One may use a coiled length of fiber section 42 selected in conjunction with the refractive index profile to at least partially cancel, or substantially totally cancel the dispersion of the transmission line 16, or a portion thereof. One may also use a portion of the transmission line 16 having a dispersion substantially opposite to a dispersion of a remaining portion of the transmission line. The sum of the two opposite types of dispersion reduces the dispersion of the transmission system 40.

When a multi-level coded optical signal is launched into transmission line 16, the optical signal having components of various frequencies tends to be dispersed due to the dependence of the index of refraction on the frequency. The optical signal, comprised of various frequency (wavelength) components, enters the dispersion compensator 41 at input port 44 and exits the dispersion compensator at output port 46. The dispersion compensator 41 applies dispersion opposite to the dispersion of the transmission line 16 and thus results in reducing the dispersion of the transmission system 40.

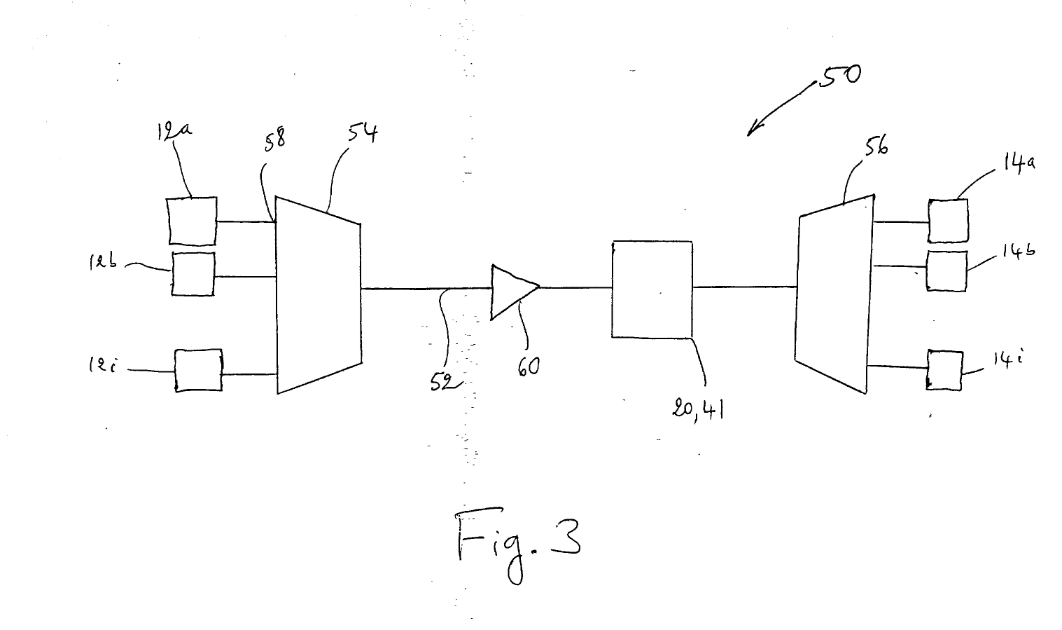

In another embodiment, as shown in FIG. 3, the optical communication system 50 includes an optical transmission line 52, a wavelength division multiplexer 54 connected to the optical transmission line 52, a wavelength division demultiplexer 56, transmitters 12a, 12b . . . and 12i, receivers 14a, 14b, . . . and 14i (i representing the ith element) and dispersion compensator 20, or 41 according to any one of the embodiments described previously. The transmitter 12 is connected to an input port 58 of the wavelength division multiplexer 54. The optical transmission line may comprise optical amplifier 60 to amplify the optical signal transmitted through optical transmission line 52. The optical signal is demultiplexed with wavelength division demultiplexer 56 and transmitted to the various receivers 14a, 14b . . . and 14i. Optical amplifier 60 can be a lumped optical amplifier or a distributed amplifier. A lumped optical amplifier may be selected from, for example, conventional erbium-doped fiber amplifiers (EDFA). Suitable distributed amplifiers include Raman amplifiers or erbium doped along a portion of the transmission line itself (optical fiber) 52.

Though the transmission system has been described in connection to its application in communication networks and systems operating in the 1550 nm low loss transmission window of the optical fiber, the transmission system technique may also be applicable to a wide range of wavelengths. Likewise, the dispersive compensator can be incorporated anywhere along the transmission line between the transmitter and the receiver including the beginning or the end of the transmission line and may even be integrated with the transmitter. The dispersive compensator can also be comprised of a plurality of dispersive compensators added separately along the transmission line such that the total added variation of propagation constant is approximately equal in magnitude and opposite in sign of the propagation constant caused by the transmission line.

While the invention has been described in connection with particular embodiments, it is to be understood that the invention is not limited to only the exemplary embodiments described, but on the contrary it is intended to cover all modifications and arrangements included within the spirit and scope of the invention as defined by the claims, which follow.

We claim:

1. An optical communication system, comprising:
an optical transmitter;
an optical transmission line in optical communication with said optical transmitter;
an optical receiver in optical communication with said optical transmission line; and
a dispersion compensator disposed between said optical transmitter and said optical receiver along said optical transmission line;
wherein said optical transmitter is adapted to transmit an optical signal that includes multilevel encoding, and
wherein said optical transmission line causes a first dispersion of said optical signal and said dispersion compensator causes a second dispersion of said optical signal, said second dispersion at least partially canceling said first dispersion.

2. An optical communication system as recited in claim 1, wherein said dispersion compensator comprises a chirped fiber Bragg grating.

3. An optical communication system as recited in claim 1, wherein said dispersion compensator comprises a length of optical fiber having different dispersion characteristics than said optical transmission line.

4. An optical communication system as recited in claim 3, wherein said length of optical fiber has a cross-sectional refractive index profile adapted to provide a dispersion substantially equal in magnitude and opposite in sign to a dispersion of said transmission line.

5. An optical communication system as recited in claim 1, further comprising:
a second optical transmitter in communication with said optical transmission line; and
an optical multiplexer arranged between said optical transmission line and the first mentioned and said second optical transmitters,
wherein said optical multiplexer is structured to form a wavelength division multiplexed optical signal from optical signals from the first mentioned and said second optical transmitters.

6. An optical communication system as recited in claim 1, wherein said multilevel coded signal is a quadrature amplitude modulated signal.

7. An optical communication system as recited in claim 1, wherein said multilevel coded signal is a quadrature phase shift keyed modulated signal.

8. An optical communication system as recited in claim 1, wherein said multilevel coded signal is an analog modulated signal.

9. An optical communication system as recited in claim 1, wherein said multilevel coded signal is a single sideband modulated signal.

10. An optical communication system as recited in claim 1, wherein said multilevel coded signal is a subcarrier modulated signal.

11. An optical communication system as recited in claim 10, wherein said subcarrier modulated signal includes at least one of a data signal, an audio signal, and a video signal.

12. An optical communication system as recited in claim 1, wherein said dispersion compensator comprises an optical circulator.

13. An optical communication system as recited in claim 1, wherein said dispersion compensator comprises an optically resonant component.

14. An optical communication system as recited in claim 1, wherein said dispersion compensator comprises a portion of said transmission line having a dispersion substantially opposite to a dispersion of a remaining portion of said transmission line.

15. An optical communication system as recited in claim 1, wherein said dispersion compensator is disposed at a beginning of said optical transmission line proximate said optical transmitter.

16. An optical communication system as recited in claim 1, wherein said dispersion compensator is disposed at an end of said optical transmission line proximate said optical receiver.

17. An optical communication system as recited in claim 1, wherein said dispersion compensator is incorporated in said optical transmitter.

18. An optical communication system as recited in claim 1, wherein said dispersion compensator comprises a plurality of chirped fiber Bragg gratings distributed along said optical transmission line.

19. An optical communication system as recited in claim 1, wherein said dispersion compensator comprises a plurality of lengths of optical fiber distributed along said optical transmission line, said plurality of optical fiber lengths having different dispersion characteristics than said optical transmission line and a sum of dispersion from said plurality of optical fiber lengths is substantially equal in magnitude and opposite in sign to a dispersion of said transmission line.

20. A method of transmitting information, comprising:
forming an optical signal comprising at least some multilevel encoding;
transmitting said optical signal between a first location and a second location in a dispersive medium, said optical signal undergoing a first dispersion; and
transmitting said optical signal through a dispersion compensator; said optical signal undergoing a second dispersion,
wherein said second dispersion at least partially cancels said first dispersion.

21. A method of transmitting information as recited in claim 20, wherein said optical signal is a quadrature amplitude modulated signal.

22. A method of transmitting information as recited in claim 20, wherein said optical signal is a duo-binary modulated signal.

23. A method of transmitting information as recited in claim 20, wherein said optical signal is an analog modulated signal.

24. A method of transmitting information as recited in claim 20, further comprising:
modulating a first electrical signal onto a first electrical carrier;
modulating a second electrical signal onto a second electrical carrier;
multiplexing said first and second modulated electrical signals to provide a subcarrier multiplexed signal prior to said forming said optical signal.

25. A method of transmitting information as recited in claim 20, further comprising:
forming a second optical signal; and
multiplexing the first mentioned optical signal and said second optical signal to form a wavelength division multiplexed optical signal.
